(19) United States
(12) Patent Application Publication
(10) Pub. No.: US 2025/0008282 A1
(43) Pub. Date: Jan. 2, 2025

(54) METHODS AND APPARATUS TO IMPROVE AUDIO QUALITY BASED ON LOAD IMPEDANCE SENSING

(71) Applicant: Intel Corporation, Santa Clara, CA (US)

(72) Inventors: Navneet Kumar Singh, Bangalore (IN); Shailendra Singh Chauhan, Bengaluru (IN); Usha, Bengaluru (IN)

(21) Appl. No.: 18/342,564

(22) Filed: Jun. 27, 2023

(51) Int. Cl. H04R 29/00; H04R 1/10; H04R 1/22

(52) U.S. Cl. CPC H04R 29/001; H04R 1/1091; H04R 1/22

(57) ABSTRACT

Example systems, apparatus, articles of manufacture, and methods to improve audio quality based on load impedance sensing are disclosed. An example apparatus disclosed herein is to cause at least one test signal to be output to an audio device, a voltage of the at least one test signal based on a default load impedance. The example apparatus disclosed herein is to execute the instructions to measure a current drawn by the audio device based on the at least one test signal. The example apparatus disclosed herein is to execute the instructions to change the voltage based on an impedance profile, the impedance profile based on the measured current.

### FIELD OF THE DISCLOSURE

This disclosure relates generally to audio quality and, more particularly, to methods and apparatus to improve audio quality based on load impedance sensing.

### BACKGROUND

A sound card is a component that enables a device such as a computer to receive, process, and output audio signals. In recent years, significant research efforts have been invested into improving the design, connectivity, and audio quality of sound cards. Improvements in sound cards have led to higher quality headphone amplification, improved output fidelity, and support for higher impedance headphones.

### BRIEF DESCRIPTION OF THE DRAWINGS

FIG. 1 is a block diagram of an example environment in which example audio enhancement circuitry operates to improve audio quality based on load impedance.

FIG. 2 is a block diagram of an example implementation of the audio enhancement circuitry of FIG. 1.

FIG. 3 is a block diagram of another example implementation of the audio enhancement circuitry of FIG. 1.

FIG. 4 is a flowchart representative of example machine readable instructions and/or example operations that may be executed, instantiated, and/or performed by example programmable circuitry to implement the audio enhancement circuitry 102 of FIG. 2.

FIG. 5 is a flowchart representative of example machine readable instructions and/or example operations that may be executed, instantiated, and/or performed by example programmable circuitry to implement the audio enhancement circuitry 102 of FIG. 2.

FIG. 6 is a block diagram of an example processing platform including programmable circuitry structured to execute, instantiate, and/or perform the example machine readable instructions and/or perform the example operations of FIGS. 4-5 to implement the audio enhancement circuitry 102 of FIG. 2.

FIG. 7 is a block diagram of an example implementation of the programmable circuitry of FIG. 6.

FIG. 8 is a block diagram of another example implementation of the programmable circuitry of FIG. 6.

FIG. 9 is a block diagram of an example software/firmware/instructions distribution platform (e.g., one or more servers) to distribute software, instructions, and/or firmware (e.g., corresponding to the example machine readable instructions of FIGS. 4-5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

In recent years, audio systems have evolved significantly, driven by advancements in semiconductor technology and the demand for higher-quality audio experiences. Audio systems can be described in terms of a host side and a peripheral side. In some examples, the host side is responsible for processing, storing, and transmitting audio signals. Host devices may be computers, media players, audio mixers, etc., and provide control over the audio system. As host devices have become more specialized, many host devices now include digital signal processors (DSPs) or discreet sound cards to provide enhanced audio experiences for listeners.

Peripheral devices in an audio system are, in some examples, external components that connect to and interact with the host. Peripheral devices can extend the functionality of the host and perform specific tasks related to audio input, output, or processing. Examples of peripheral devices include speakers, headphones, microphones, digital instruments, etc. To connect peripheral devices to the host, systems have traditionally relied on analog connections, such as 3.5 millimeter (mm) connectors, which provide an analog signal to the host for processing. However, with the advent of Universal Serial Bus Type-C (USB-C™) connectors, which are reversible connectors that can be used to transmit data, audio signals, and power, the landscape of audio interfaces has undergone a significant transformation.

USB-C™ offers many advantages over traditional analog connections, including space savings that allow device manufacturers to create thinner devices than possible with traditional 3.5 mm headphone jacks. USB-C™ also allows for integration of sound card functionality into USB-C™ devices, such as laptops, tablets, and smartphones. Accordingly, USB-C™ and other digital connectors have become popular, with current and future devices integrating USB-C™ into their designs.

Despite the improvements in functionality and quality, USB-C™ presents new challenges in the design and manufacture of high quality audio systems. Digital audio processing involves converting analog signals into discrete digital values, which introduces quantization and sampling that inherently change the nature of the audio. Furthermore, utilizing USB-C™ may introduce compatibility challenges with legacy analog sound equipment. To accommodate such sound equipment, USB-C™ supports audio accessory mode, which allows analog audio to be passed over a USB-C™ connector. Left and right analog audio is passed through the USB-C™ connector through the D+ and D− lines of the USB Type-C™ connector.

Although passing analog audio through USB-C is possible with a standard 3.5 mm to USB-C™ connector, such a configuration can present many challenges. One challenge that arises with USB-C™ in audio accessory mode is providing an ability to adapt to different load impedances and to provide a proper power level to the load device. An impedance mismatch can result in suboptimal audio quality, distortion, or insufficient power transfer, leading to an unsatisfactory listening experience.

Prior solutions have attempted to address this issue through various means, including the use of dedicated headphone amplifiers, impedance adapters, or manual configuration settings. However, these solutions often add complexity, require additional components, or lack adaptability to different audio peripherals. At least some examples disclosed herein overcome the limitations of such prior solutions by dynamically changing power provided to a peripheral audio device based on an impedance profile determined from current measured as at least one test signal is provided to the audio device.

At least some disclosed examples provide enhanced audio fidelity, audio clarity, and reduced power loss, while protecting the circuitry of the audio device. To provide such benefits, examples disclosed herein sense impedance characteristics of a peripheral audio device and dynamically adjust the output power of a host device to improve power transfer. At least some disclosed examples provide adaptive power delivery based on the load impedance to ensure efficient power transfer, satisfactory audio reproduction, and compatibility with a wide range of headphones, speakers, and other peripheral audio devices. At least some disclosed examples provide benefits for audio enthusiasts, professionals, as well as general users seeking an enhanced audio experience.

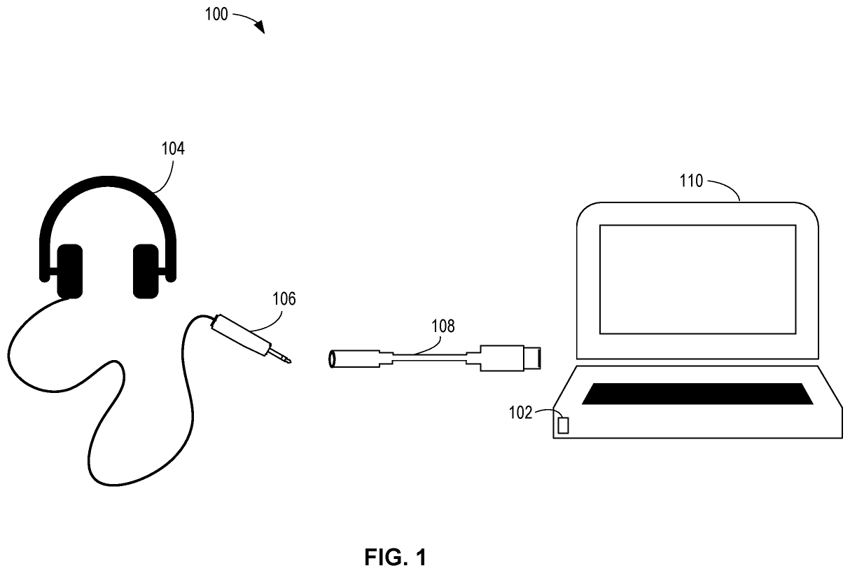

FIG. 1 is a block diagram of an example system 100 in which example audio enhancement circuitry 102 operates to improve audio quality based on load impedance. The system 100 of FIG. 1 includes the audio enhancement circuitry 102, an example peripheral audio device 104, an example 3.5 mm connector 106, an example USB-C™ adapter 108, and an example host device 110. As shown in FIG. 1, the peripheral audio device 104 is an example analog headphones 104 connected to the USB-C™ adapter 108, which in turn connects to the host device 110. However, in other examples, the peripheral audio device 104 can be any audio output device, such as one or more speakers, headphones, digital instruments, etc. As shown in FIG. 1, the host device 110 is an example computer 110. However, in other examples, the host device 110 can be any device capable of generating, presenting, or otherwise hosting audio, such as a mobile phone, a media device (e.g., a television, a tablet computer, a digital billboard), a server, etc.

In some examples, the headphones 104 are a pair of high impedance headphones. In general, different headphones can have different impedances. In a high impedance headphone (e.g., greater than 20 ohms, greater than 50 ohms, greater than 100 ohms, etc.) the wiring is typically thinner than low impedance headphones (e.g., lower than 30 ohms). The thinner wiring of high impedance headphones enables headphone manufacturers to wind more wire tightly than for low impedance headphones. The greater wiring creates more magnetic force to move the coil's diaphragm, making the core lighter and more responsive. As a result, high impedance headphones 104 can have lower distortion, better dynamics and more accurate sound representation than low impedance headphones. Although examples disclosed herein are described in association with high impedance headphones, the methods and apparatus described herein are compatible with any headphones, including low impedance headphones (e.g., less than 50 ohms, less than 30 ohms, less than 5 ohms, etc.).

In the illustrated example, the headphones 104 are high impedance headphones that are coupled to a 2.5 mm headphone jack 106. The 2.5 mm headphone jack 106 is connected to the computer 110 via the 3.5 mm to USB-C™ adapter 108. As noted above, different audio devices connected to the computer 110 can have different load impedances. The audio enhancement circuitry 102 allows the computer 110 to measure the impedance of the high impedance headphones 104 and determine how to adjust power and/or equalize (e.g., tune, configure, etc.) based on the measured impedance of the headphones 104 for improved performance.

For example, the computer 110 can, based on the audio enhancement circuitry 102, drive headphones having low impedance with a low root-mean-square voltage (Vrms), while driving headphones such as the high impedance headphones 104 with a relatively higher Vrms. Furthermore, the system 100 does not have an additional amplifier outside the audio enhancement circuitry 102. This simplifies the audio listening process for a user, as they can simply plug the high impedance headphones 104 into the audio enhancement circuitry 102 (e.g., via a 3.5 mm to USB-C™ adapter, directly connect a USB-C™ compatible device, a non USB-C™ device, etc.) without the need for an additional amplifier that adds both complexity and cost to the headset peripheral.

The audio enhancement circuitry 102 may be coupled to a USB-C™ adapter 108. As the audio enhancement circuitry 102 provides compatibility with high impedance headphones, users of the high impedance headphones can, based on the audio enhancement circuitry 102, listen to audio with less distortion, more defined bass, and generally higher quality audio than a corresponding low impedance set of headphones. To achieve improved audio performance, the audio enhancement circuitry 102 can adjust power delivery based on a measured load impedance, as will be described in association with the figures below.

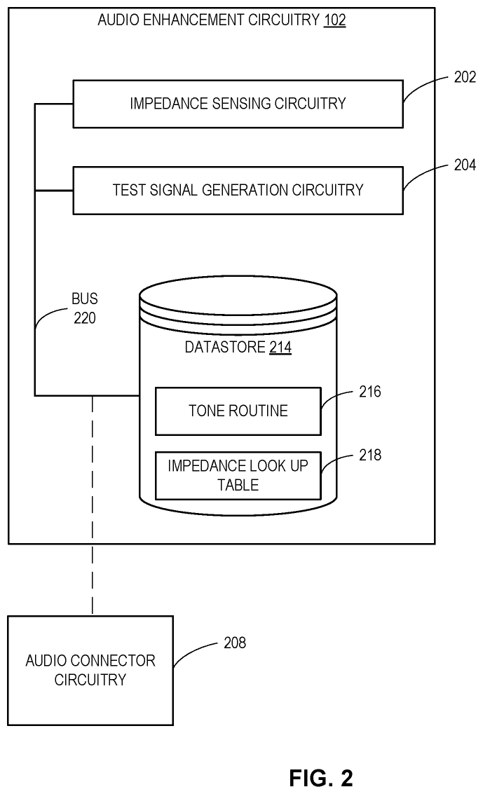

FIG. 2 is a block diagram of an example implementation of the audio enhancement circuitry 102 of FIG. 1 to improve audio quality based on load impedance. The audio enhancement circuitry 102 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the audio enhancement circuitry 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The audio enhancement circuitry 102 includes example impedance sensing circuitry 202, example test signal generation circuitry 204, an example datastore 214, an example tone routine 216, an example impedance look up table 218, an example bus 220. The audio enhancement circuitry 102 is coupled to example audio connector circuitry 208 via the bus 220.

The audio enhancement circuitry 102 includes the impedance sensing circuitry 202. The impedance sensing circuitry 202 may determine how much power the audio enhancement circuitry 102 should deliver (e.g., to a pair of high impedance headphones) to a peripheral audio device (e.g., the peripheral audio device 104 of FIG. 1), as well as how much power the audio enhancement circuitry 102 can receive. This allows for proper power to be provided to audio peripheral devices based on their load impedance. In other example implementations the impedance sensing circuitry 202 can be included in other components of the host device, such as a codec, driver, etc., that receives instruction, configuration data, etc., from the audio enhancement circuitry 102.

As will be described in association with an embodiment of the audio enhancement circuitry 102, the impedance sensing circuitry 202 may include current sensing circuitry (e.g., current measurement circuitry) to sense a current that is drawn by the peripheral audio device 104 when a test signal is provided to the audio peripheral 104. In some examples, the impedance sensing circuitry 202 repurposes an existing current measurement feature included in the host device 110 to avoid overloading a connected USB-C™ source and a current configure (CC) line. The CC line may be coupled to a logic block to determines cable detection, cable orientation and current characteristics. In some examples, the impedance sensing circuitry 202 includes current sensing circuitry that is specialized for sensing the current generated when a series of test signals is output to the audio peripheral 104, as described herein.

In some examples, the impedance sensing circuitry 202 conforms to the USB™ power delivery standard Revision 3.1 of April 2023 (e.g., and/or earlier or later versions of the standard) and allows for supplying an output voltage of 5 V, 9 V, 15 V, or 20 V, etc., at power levels up to 100 watts. In some examples, the impedance sensing circuitry 202 assumes a default load impedance of the peripheral audio device 104 coupled to the host device 110. For example, the impedance sensing circuitry 202 may assume a default load impedance of the connected device 104 is 30 ohms or some other default impedance that is relatively low. Such an assumption is unlikely to damage the connected device, as 30 ohms is a standard headphone impedance. Then, the impedance sensing circuitry 202 may receive one or more test signals from the audio codec circuitry 204, which can be sent to the connected device 104 at an initial default voltage corresponding to the default load impedance. To determine an actual impedance of the headphones, the impedance sensing circuitry 202 (e.g., via the current sensor circuitry 312) may measure a current to the connected device 104 as the test signal(s) is (are) transmitted to the connected device 104, and then change the output voltage provided to the connected device 104 based on the impedance profile determined from the measured current and the test signal(s).

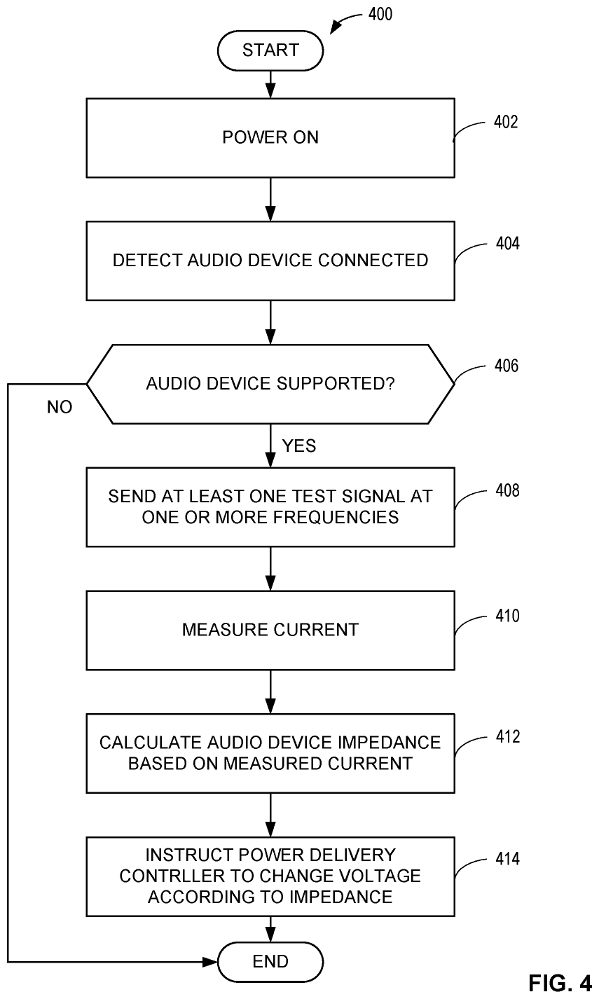

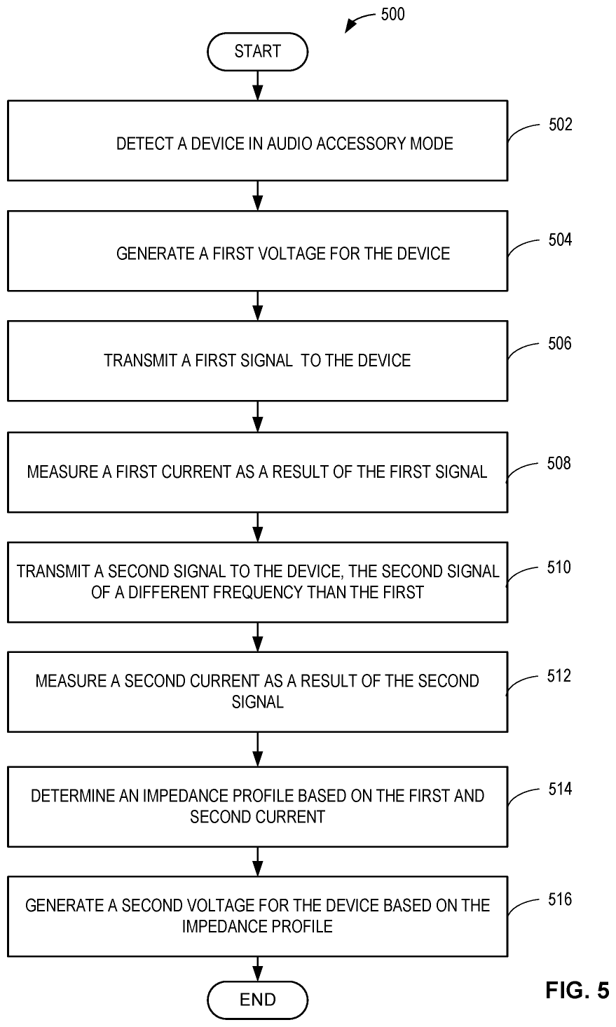

In some examples, the impedance sensing circuitry 202 is instantiated by programmable circuitry executing power delivery instructions and/or configured to perform operations such as those represented by the flowchart(s) of FIGS. 4-5.

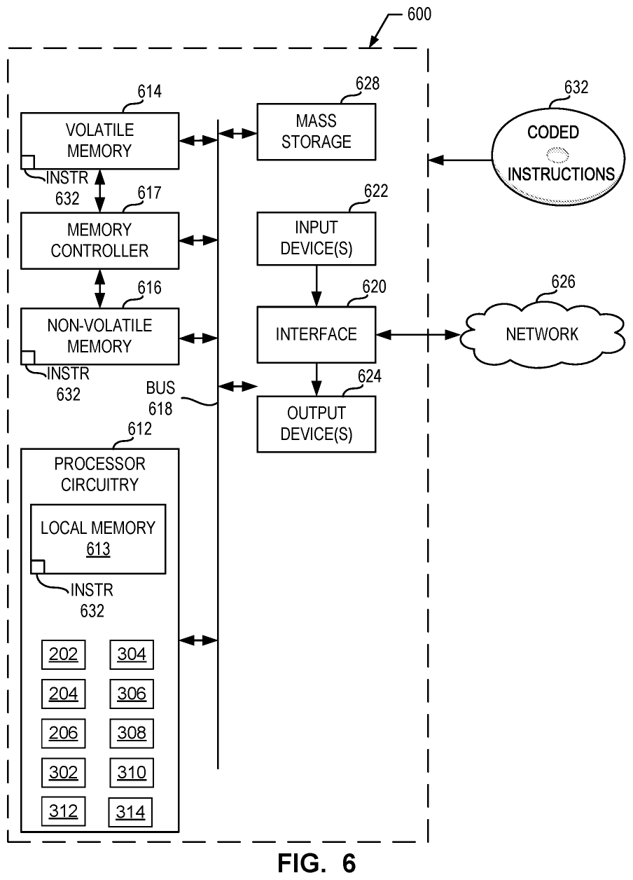

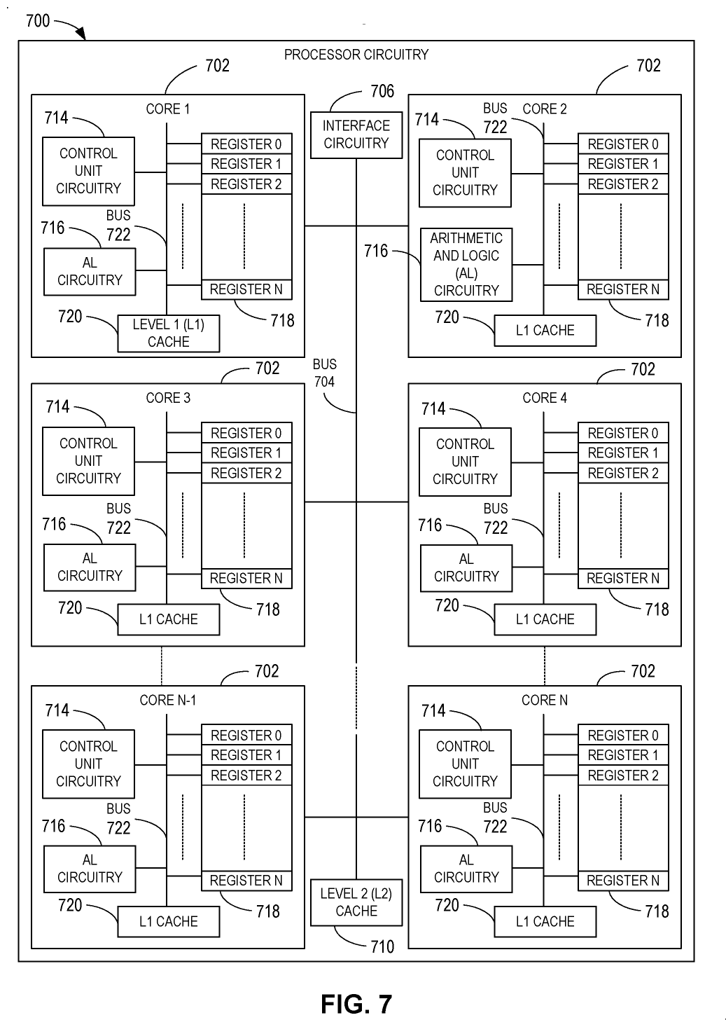

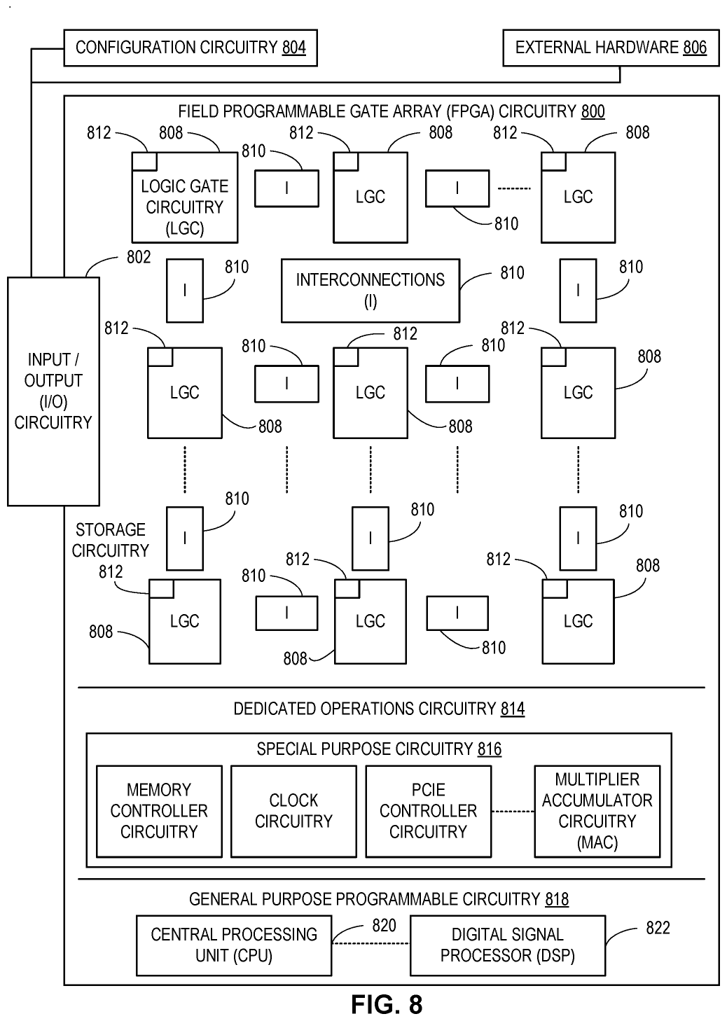

In some examples, the audio enhancement circuitry 102 includes means for sensing (e.g., measuring) a current to the speaker as the at least one test signal is transmitted to the peripheral audio device and changing an output voltage that powers an audio peripheral device based on the impedance profile determined from the measured current and the at least one test signal. For example, the means for measuring and/or changing may be implemented by impedance sensing circuitry 202. In some examples, the impedance sensing circuitry 202 may be instantiated by programmable circuitry such as the example programmable circuitry 612 of FIG. 6. For instance, the impedance sensing circuitry 202 may be instantiated by the example microprocessor 700 of FIG. 7 executing machine executable instructions such as those implemented by at least blocks 504, 516 of FIG. 5. In some examples, the impedance sensing circuitry 202 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, impedance sensing circuitry 202 may be instantiated by any other combination of hardware, software, and/or firmware. For example, the impedance sensing circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The audio enhancement circuitry 102 includes test signal generation circuitry 204. The test signal generation circuitry 204 can encode analog audio as digital signals and/or decode the digital signal back into analog. The test signal generation circuitry 204 can generate one or more test signals to send to a load (e.g., a headphone) to facilitate an impedance measurement.

In the illustrated example, the test signal generation circuitry 204 generates and transmits (e.g., sends) at least one test signal to the peripheral audio device 104 via a power delivery controller, with a voltage of the at least one test signal based on an assumed default impedance (e.g., that of a 30 ohm headphone). In some examples, a frequency of the at least one test signal is selected to facilitate determination of an impedance profile of the peripheral audio device (e.g., 1 kilohertz (kHz) signal). For example, the test signal generation circuitry 204 may transmit one or more signals at a default lower voltage (e.g., a voltage suitable for a 30 ohm impedance). The test signal generation circuitry 204 may then send signals at various frequencies (e.g., 1 kHz, 10 kHz, 100 kHz, etc.) to determine an impedance profile of the peripheral audio device.

In some examples, the test signal generation circuitry 204 is instantiated by programmable circuitry executing test signal generation circuitry 204 instructions and/or configured to perform operations such as those represented by the flowchart(s) of FIGS. 4-5.

In some examples, the audio enhancement circuitry 102 includes means for sending at least one test signal to the peripheral audio device via a power delivery controller, a voltage of the at least one test signal based on the assumed impedance, a frequency of the at least one test signal to facilitate determination of an impedance profile of the peripheral audio device. For example, the means for sending may be implemented by the test signal generation circuitry 204. In some examples, the test signal generation circuitry 204 may be instantiated by programmable circuitry such as the example programmable circuitry 612 of FIG. 6. For instance, the test signal generation circuitry 204 may be instantiated by the example microprocessor 700 of FIG. 7 executing machine executable instructions such as those implemented by at least blocks 506 and 510 of FIG. 5. In some examples, the test signal generation circuitry 204 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the test signal generation circuitry 204 may be instantiated by any other combination of hardware, software, and/or firmware. For example, the test signal generation circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The audio enhancement circuitry 102 is coupled to the audio connector circuitry 208, which in the illustrated example is a USB-C™ connector. However, although examples disclosed herein are described in association with USB-C™, the audio connector circuitry 208 may be any other type of connector that is capable of providing an analog and/or digital signal to the audio enhancement circuitry 102 (e.g., Thunderbolt™, DisplayPort™, etc.).

In some examples, the audio connector circuitry 208 is instantiated by programmable circuitry executing audio connector circuitry instructions and/or configured to perform operations such as those represented by the flowchart(s) of FIGS. 5-6.

In some examples, the audio enhancement circuitry 102 includes means for coupling an audio peripheral. For example, the means for coupling may be implemented by audio connector circuitry 208. In some examples, the audio connector circuitry 208 may be instantiated by programmable circuitry such as the example programmable circuitry 612 of FIG. 6. For instance, the audio connector circuitry 208 may be instantiated by the example microprocessor 700 of FIG. 7 executing machine executable instructions such as those implemented by at least block 502 of FIG. 5. In some examples, audio connector circuitry 208 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the audio connector circuitry 208 may be instantiated by any other combination of hardware, software, and/or firmware. For example, the audio connector circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The audio enhancement circuitry 102 includes the datastore 214. The datastore 214 may store tone data and/or a table of information that maps measured currents to impedances. For example, the datastore 214 may include a lookup table that correlates (e.g., as a key-value pair) one or more currents based on a current to impedance mapping. In some examples, the lookup table may be a hash table. In the example audio enhancement circuitry 102, the datastore 214 stores a tone routine 216. The tone routine 216 is a series of tones (e.g., signals) that can be transmitted to a peripheral audio device to determine an impedance profile of the peripheral audio device. For example, the tone routine 216 may be a series of tones at 1 kilohertz (kHz), 10 kHz, etc., that can be generated by test signal generation circuitry 204 and transmitted, via the power delivery controller circuitry 302, to a high impedance headphone.

The datastore 214 may also store the impedance look up table 218. The impedance look up table 218 may be a look up table that provides an expected impedance when a current is sensed by the power delivery controller circuitry 302. The bus 220 may provide communication between any of the elements of the audio enhancement circuitry 102.

In some examples, the audio enhancement circuitry 102 includes means for storing tone and/or impedance data. For example, the means for storing may be implemented by datastore 214. In some examples, the datastore 214 may be instantiated by programmable circuitry such as the example programmable circuitry 612 of FIG. 6. For instance, the datastore 214 may be instantiated by the example microprocessor 700 of FIG. 7 executing machine executable instructions such as those implemented by at least block 412 of FIG. 4. In some examples, the datastore 214 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the datastore 214 may be instantiated by any other combination of hardware, software, and/or firmware. For example, the datastore 214 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

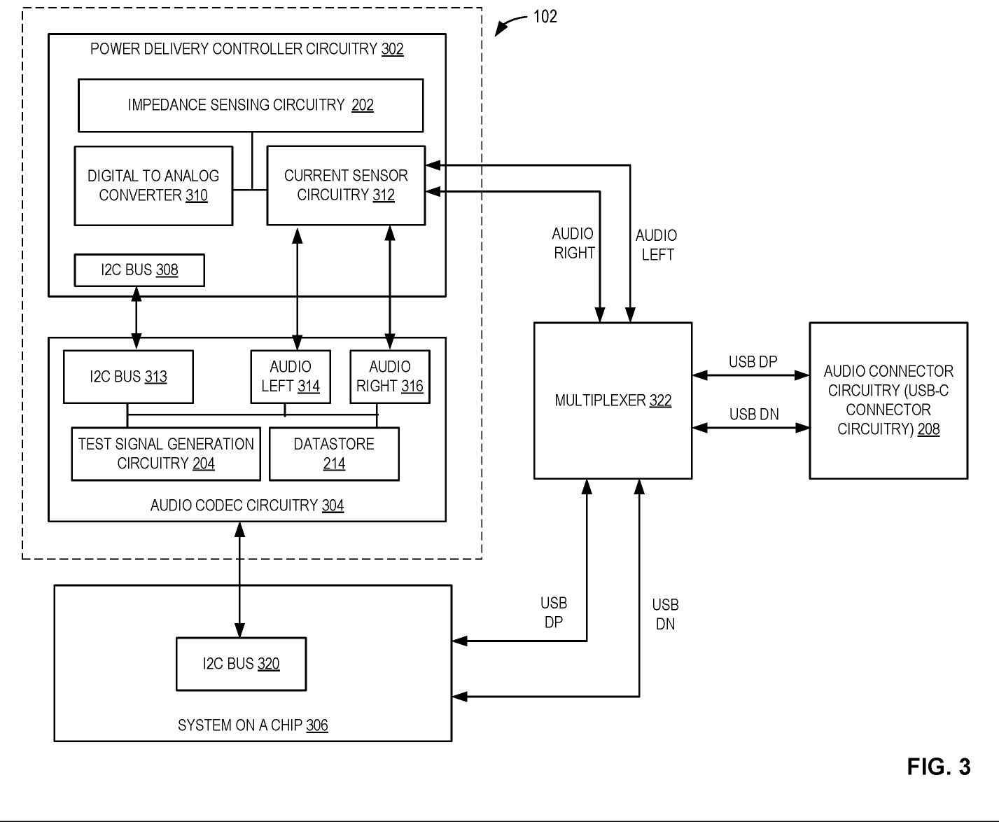

FIG. 3 is a block diagram of another example implementation of the audio enhancement circuitry 102 of FIGS. 1 and 2. The block diagram of FIG. 3 illustrates one example of how components of the audio enhancement circuitry 102 may be connected to elements such as a system on a chip 306, a multiplexer 322, and/or the audio connector circuitry 208. However, in some examples the audio enhancement circuitry 102 may include additional elements. For example, the audio enhancement circuitry 102 may include a system on a chip that includes test signal generation circuitry.

The following description provides an example of how an example audio enhancement circuitry 102 functions in operation. The power delivery controller circuitry 302 includes an example digital to analog converter 310, an example current sensor circuitry 312, and an example I2C bus 308.

The current sensor circuitry 312 may be implemented using any current sensing circuit. For example, the current sensor circuitry 312 may be implemented by sensing a voltage drop across a shunt or current-sense resistor. However, the current sensor circuitry 312 is not limited to current sensing via a contacted (e.g., shunt-based) method. For example, the current sensor circuitry 312 may perform current sensing based on a contactless (e.g., magnetic or coil based) methods.

In some examples, the current sensor circuitry 312 senses current to a peripheral audio device that is provided a constant voltage (e.g., a reference voltage) by the power delivery controller circuitry 302. Then, as the test signal generation circuitry 204 sends one or more signals at different frequencies (e.g., frequencies to determine an impedance profile of the load), the current sensor circuitry 312 can measure a current resulting from the signals. For example, the current sensor circuitry 312 of the power delivery controller circuitry 302 may sense a current of a circuit including a headphone of an unknown impedance profile, the test signal generation circuitry 204 may then provide instructions to the power delivery controller circuitry 302 to increase a voltage associated with the audio enhancement circuitry 102 output.

In some examples, current sensor circuitry 312 is instantiated by programmable circuitry executing current sensing instructions and/or configured to perform operations such as those represented by the flowchart(s) of FIGS. 4-5.

In some examples, the audio enhancement circuitry 102 includes means for sensing a current of a device. For example, the means for sensing may be implemented by current sensor circuitry 312. In some examples, the current sensor circuitry 312 may be instantiated by programmable circuitry such as the example programmable circuitry 612 of FIG. 6. For instance, the current sensor circuitry 312 may be instantiated by the example microprocessor 700 of FIG. 7 executing machine executable instructions such as those implemented by at least block 410 of FIG. 4. In some examples, current sensor circuitry 312 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the current sensor circuitry 312 may be instantiated by any other combination of hardware, software, and/or firmware. For example, the current sensor circuitry 312 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The audio enhancement circuitry 102 is coupled to the system on a chip (SoC) 306. In the illustrated example, the SoC 306 is circuitry that is dedicated to audio processing. In some examples, the SoC 306 acts as an interface between the audio enhancement circuitry 102 and the central processing unit (CPU) of the host device 110. The system on a chip 306 may receive signals, for example, from a USB physical layer (PHY). As used herein, PHY is the abbreviation for the physical layer of the system on a chip 306. The PHY is used to connect a peripheral audio device to the physical medium. That is, the PHY may be integrated into a USB controller in hosts or embedded systems and provides the bridge between the digital and modulated parts of the interface. For example, the audio enhancement circuitry 102 can act as a USB controller, performing functions such as serialization, deserialization, encoding, decoding, obtaining a required data transmission rate, etc.

In some examples, the system on a chip 306 can generate training tones to be used as the test signals (e.g., tones at a reference Vrms with varying frequencies), in combination with or alternatively to the test signal generation circuitry 204. In such an example, the system on a chip 306 can communicate with the test signal generation circuitry 204 and generate the tones for the power delivery controller circuitry 302 to transmit to a peripheral audio device. That is, the tones may be test signals sent before operation of the audio peripheral device.

In some examples, the system on a chip 306 is instantiated by programmable circuitry executing system on a chip 306 instructions and/or configured to perform operations such as those represented by the flowchart(s) of FIGS. 4-5.

In some examples, the audio enhancement circuitry 102 includes means for communicating with an audio peripheral. For example, the means for communicating may be implemented by system on a chip 306. In some examples, the system on a chip 306 may be instantiated by programmable circuitry such as the example programmable circuitry 612 of FIG. 6. For instance, the system on a chip 306 may be instantiated by the example microprocessor 700 of FIG. 7 executing machine executable instructions such as those implemented by at least blocks 404, 408, and 412 of FIG. 4. In some examples, the system on a chip 306 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the system on a chip 306 may be instantiated by any other combination of hardware, software, and/or firmware. For example, the system on a chip 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

Various components of the audio enhancement circuitry 102 are coupled (e.g., connected). For example, the power delivery controller circuitry 302 also includes an example inter-integrated circuit (I2C) communication bus 308 to facilitate communication with the audio codec circuitry 304 (e.g., including the test signal generation circuitry 204). The digital to analog converter 310, the current sensor circuitry 312, and the impedance sensing circuitry 202 are coupled. The current sensor circuitry 312 also receives audio signals from an audio left 314 and an audio right 316.

The audio codec circuitry 204 includes an example I2C bus 313, which is coupled to the power delivery controller circuitry 302. The audio codec circuitry 204 also includes example audio left 314 and audio right 316, each of which are coupled to the current sensor circuitry 312. The audio codec circuitry 204 is coupled to the system on a chip 306 via the I2C bus 320. The system on a chip 306 and the power delivery controller circuitry 302 are both coupled to an example multiplexer 322.

The USB-C™ connector circuitry 208 includes a negative data terminal (DN), and a positive data terminal (DP). The multiplexer 322 is coupled to the USB-C™ connector circuitry 208 via the USB-C™ DP and USB-C™ DN pins. In operation, the audio enhancement circuitry 102 is coupled to a pair of high impedance headphones. The audio codec circuitry 304 (e.g., based on the test signal generation circuitry 204) may send signals that cause the power delivery controller circuitry 302 to change an amount of power delivered to an audio peripheral device. In some examples, the power delivery controller circuitry 302 may be provided analog signals by the audio codec circuitry. The peripheral audio device is connected over USB-C™ DP and USB-C™ DN pins to the multiplexer 322. The multiplexer 322 may transmit signals to the audio peripheral device. The multiplexer 322 may also transmit digital signals to the system on a chip 306 (e.g., USB PHY) for processing.

Although not illustrated in FIG. 3, in some examples, the USB-C™ connector circuitry 208 includes two pins, CC1 and CC2, that can establish and manage the connection to a peripheral audio device. The USB-C™ connector circuitry 208 CC lines are pulled down in audio accessory mode and are connected to the power delivery controller circuitry 302. Based on different load impedances, the power/current on the audio output signal can vary. The current sensor circuitry 312 can then determine the power/current on the audio left and audio right lines based on the varying loads.

In the illustrated example of FIG. 3, the power delivery controller circuitry 302 includes the current sensor circuitry 312 (e.g., as an analog I/O) that is internal to power delivery controller circuitry 302. The current sense circuitry 312 can determine a current of an analog audio signal from the audio codec circuitry 204 to the multiplexer 322 and then to the USB-C™ connector circuitry 208. The current information can then be passed to the digital to analog converter 310.

In the illustrated example, the audio codec circuitry 204 sends a training sequence in the audio spectrum (e.g., frequencies that humans can hear, 20 Hz to 20,000 Hz, etc.) after the USB-C™ connector circuitry 208 (e.g., via CC pins) detects a peripheral audio device in audio accessory mode. As the voltage on the audio output by the USB-C™ connector circuitry 208 is constant, the current will vary as a training sequence is transmitted to a peripheral audio device via the USB-C™ connector circuitry 208. The current can be measured by the current sensor circuitry 312. Then, with the current sensor data from power delivery controller circuitry 302, a load impedance can be measured.

The power delivery controller circuitry 302 can communicate DAC information to the audio codec circuitry 204 over an I2C interface, for example. Once a load impedance is identified, the audio codec circuitry 204 can adjust power delivered to the headphones. Therefore, the audio enhancement circuitry 102 improves the audio output performance/quality based on the audio codec circuitry 204.

While an example manner of implementing the audio enhancement circuitry 102 of FIG. 1 is illustrated in FIGS. 2 and 3, one or more of the elements, processes, and/or devices illustrated in FIGS. 2 and 3 may be combined, divided, re-arranged, omitted, eliminated, and/or implemented in any other way. Further, the example power delivery controller circuitry 302, the example audio codec circuitry 304, the example system on a chip 306, the example audio connector circuitry 208, the example digital to analog converter 310, the example current sensor circuitry 312, the example datastore 214, and/or, more generally, the example audio enhancement circuitry 102 of FIGS. 2 and 3, may be implemented by hardware alone or by hardware in combination with software and/or firmware. Thus, for example, any of the example power delivery controller circuitry 302, the example audio codec circuitry 304, the example system on a chip 306, the example audio connector circuitry 208, the example digital to analog converter 310, the example current sensor circuitry 312, the example datastore 214, and/or, more generally, the example audio enhancement circuitry 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example audio enhancement circuitry 102 of FIGS. 2 and 3 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the audio enhancement circuitry 102 of FIGS. 2 and/or 3, and/or representative of example operations which may be performed by programmable circuitry to implement and/or instantiate the audio enhancement circuitry 102 of FIGS. 2 and/or 3, are shown in FIGS. 4-5. The machine readable instructions may be one or more executable programs or portion(s) of one or more executable programs for execution by programmable circuitry such as the processor circuitry 612 shown in the example processor platform 600 discussed below in connection with FIG. 6 and/or may be one or more function(s) or portion(s) of functions to be performed by the example programmable circuitry (e.g., an FPGA) discussed below in connection with FIGS. 7 and/or 8. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4-5, many other methods of implementing the example audio enhancement circuitry 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4-5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 4 is a flowchart representative of example machine readable instructions and/or example operations 400 that may be executed, instantiated, and/or performed by programmable circuitry to implement the audio enhancement circuitry 102. The example machine-readable instructions and/or the example operations 400 of FIG. 4 begin at block 402, at which the audio enhancement circuitry 102 is powered on. For example, a user may power on the computer 110, which includes a sound card with the audio enhancement circuitry 102. In some examples, a user may plug in a USB-C™ connector to the audio connector circuitry 208, triggering a power on of the audio enhancement circuitry 102.

Then, at block 404, the example audio connector circuitry 208 detects that the audio peripheral device 104 has been connected to the audio enhancement circuitry 102. For example, the audio connector circuitry 208 may identify that a device is a USB-C™ device. In some examples, the USB-C™ connector circuitry 208 may determine that at least one of two CC lines are pulled down and therefore detect that the audio peripheral device 104 is connected.

At block 406, the example audio connector circuitry 208 may determine that the audio peripheral device 104 is capable of supporting USB-C™ audio accessory mode. For example, the audio connector circuitry 208 may include a circuit to detect that a 3.5 mm to USB-C™ audio adapter is being used with the audio peripheral device 104 (e.g., high impedance headphones). The power delivery controller circuitry 302 and/or the audio connector circuitry 208 may also assume a default load impedance of the audio peripheral device 104 that is coupled to the host device 110. For example, the audio enhancement circuitry 102 may assume that the peripheral audio device 104 connected to the audio connector circuitry 208 has a 30 ohm load impedance. The power delivery controller circuitry 302 and/or the audio codec circuitry 204 may then determine a reference power level and/or voltage to transmit test signals (e.g., signals to determine an impedance or impedance profile of the audio peripheral 104) to the audio peripheral device 104. If, at block 406, the audio connector circuitry 208 determines that the audio peripheral device 104 is not supported (e.g., is not compatible with USB audio accessory mode, is not a USB device, etc.), the instructions end. Otherwise, the instructions continue at block 408.

At block 408, the example audio codec circuitry 304 sends at least one test signal to the audio peripheral device 104. For example, the audio codec circuitry 204 may send at least one test signal to the audio peripheral device 104 via a power delivery controller circuitry 302, with a voltage of the at least one test signal based on the assumed impedance (e.g., 30 ohms), and a frequency of the at least one test signal to facilitate determination of an impedance profile of the audio peripheral device 104 (e.g., a single tone at 1 kHz). In some examples, the at least one test signal includes two, three, four, or more test signals (e.g., a first test signal at 1 KHz, a second test signal at 2 kHz, a third test signal at 3.5 kHz, etc.). Therefore, there may be a series of test signals of varying (e.g., increasing) frequency. In some examples, one or more of the test signals may form a melody. In such a scenario, the test signals may not be in increasing frequency, and may instead be organized in a pattern to create a musical tune. That is, the audio codec circuitry 204 and/or the system on a chip 306 may generate and transmit a series of test signals (e.g., one or more test signals) at varied frequencies, with differing intervals between the frequencies, to generate a test sequence that is more pleasing to the human ear than a set of test signals that have no musical characteristics.

At block 410, the example current sensor circuitry 312 measures a current drawn by the audio peripheral device 104 based on the one or more test signals. The current sensor circuitry 312 may be included in the power delivery controller circuitry 302. The current sensor circuitry 312 may use an integrated resistor current sensor, a shunt-based current sensing circuit, etc.

Then, at block 412, the example audio codec circuitry 304 calculates a load impedance or load impedance profile of the audio peripheral 104 based on a measured current. For example, the audio codec circuitry 204 may look up an impedance from a look up table (e.g., a circuitry look up table, a database in memory, etc.). based on the reference output voltage of the test signal(s) and the measured current draw.

At block 414, the example system on a chip 306 instructs the power delivery controller circuitry 302 to change the voltage transmitted to the audio peripheral device 104. For example, the power delivery controller circuitry 302 may have sent a first signal at an assumed power level (e.g., voltage for a low impedance headset), but after calculating the audio peripheral device 104 impedance (e.g., identifying a high impedance headset is connected) the power delivery controller circuitry 302 may increase a power level to provide appropriate power to the audio peripheral device 104. The instructions end, but may be repeated if, for example, another headset is plugged in.

FIG. 5 is another flowchart representative of example machine readable instructions and/or example operations 500 that may be executed, instantiated, and/or performed by programmable circuitry to modify an output signal based on impedance sensing. The example machine-readable instructions and/or the example operations 500 of FIG. 5 begin at block 502, at which the audio connector circuitry 208 detects the audio peripheral device 104 in audio accessory mode. At block 504, the example power delivery controller circuitry 302 generates a first voltage (e.g., a reference voltage) for the device.

Then, at block 506, the example system on a chip 306 and/or the audio codec circuitry 204 generates and transmits a first test signal to the audio peripheral device 104 (e.g., a 1 kHz tone). At block 508, the example current sensor circuitry 312 measures a first current drawn by the audio peripheral device 104 as a result of the first signal.

At block 510, the example audio codec circuitry 304 and/or system on a chip 306 transmits a second signal to the device, the second signal of a different frequency than the first. For example, the system on a chip 306 may (e.g., rather than the audio codec circuitry 204), generate test tones for the audio enhancement circuitry 102. Then, at block 512, the example current sensor circuitry 312 measures a second current (e.g., resulting from the second signal).

At block 514, the example system on a chip 306 and/or audio connector circuitry 208 determines an impedance profile based on the first and second currents. The power delivery controller circuitry 302 then generates a second voltage for the device based on the impedance profile. The instructions end.

FIG. 6 is a block diagram of an example programmable circuitry platform 600 structured to execute and/or instantiate the example machine-readable instructions and/or the example operations of FIGS. 4-5 to implement the audio enhancement circuitry 102 of FIG. 2. The programmable circuitry platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements impedance sensing circuitry 202 and the test signal generation circuitry 204.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-site wireless system, a line-of-site wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 632, which may be implemented by the machine readable instructions of FIGS. 4-5, may be stored in the mass storage device 628, in the volatile memory 614, in the non-volatile memory 616, and/or on at least one non-transitory computer readable storage medium such as a CD or DVD which may be removable.

FIG. 7 is a block diagram of an example implementation of the programmable circuitry 612 of FIG. 6. In this example, the programmable circuitry 612 of FIG. 6 is implemented by a microprocessor 700. For example, the microprocessor 700 may be a general-purpose microprocessor (e.g., general-purpose microprocessor circuitry). The microprocessor 700 executes some or all of the machine-readable instructions of the flowcharts of FIGS. 4-5 to effectively instantiate the circuitry of FIG. 2 as logic circuits to perform operations corresponding to those machine readable instructions. In some such examples, the circuitry of FIG. 2 is instantiated by the hardware circuits of the microprocessor 700 in combination with the machine-readable instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIGS. 4-5.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating-point operations. In yet other examples, the AL circuitry 716 may include first AL circuitry that performs integer-based operations and second AL circuitry that performs floating-point operations. In some examples, the AL circuitry 716 may be referred to as an Arithmetic Logic Unit (ALU).

The registers 718 are semiconductor-based structures to store data and/or instructions such as results of one or more of the operations performed by the AL circuitry 716 of the corresponding core 702. For example, the registers 718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure, such as by being distributed throughout the core 702 to shorten access time. The second bus 722 may be implemented by at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages.

The microprocessor 700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 700, in the same chip package as the microprocessor 700 and/or in one or more separate packages from the microprocessor 700.

FIG. 8 is a block diagram of another example implementation of the programmable circuitry 612 of FIG. 6. In this example, the programmable circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 700 of FIG. 7 described above (which is a general purpose device that may be programmed to execute some or all of the machine readable instructions represented by the flowchart(s) of FIGS. 4-5 but whose interconnections and logic circuitry are fixed once fabricated), the FPGA circuitry 800 of the example of FIG. 8 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4-5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4-5. As such, the FPGA circuitry 800 may be configured and/or structured to effectively instantiate some or all of the operations/functions corresponding to the machine readable instructions of the flowchart(s) of FIGS. 4-5 as dedicated logic circuits to perform the operations/functions corresponding to those software instructions in a dedicated manner analogous to an ASIC. Therefore, the FPGA circuitry 800 may perform the operations/functions corresponding to the some or all of the machine readable instructions of FIGS. 4-5 faster than the general-purpose microprocessor can execute the same.

In the example of FIG. 8, the FPGA circuitry 800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain a binary file, which may be implemented by a bit stream, data, and/or machine-readable instructions, to configure the FPGA circuitry 800, or portion(s) thereof. In some such examples, the configuration circuitry 804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 806 may be implemented by external hardware circuitry. For example, the external hardware 806 may be implemented by the microprocessor 700 of FIG. 7.

The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations/functions that may correspond to at least some of the machine readable instructions of FIGS. 4-5 and/or other desired operations. The logic gate circuitry 808 shown in FIG. 8 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations/functions. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example dedicated operations circuitry 814. In this example, the dedicated operations circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the programmable circuitry 612 of FIG. 6, many other approaches are contemplated. For example, FPGA circuitry may include an on-board CPU, such as one or more of the example CPU 820 of FIG. 7. Therefore, the programmable circuitry 612 of FIG. 6 may additionally be implemented by combining at least the example microprocessor 700 of FIG. 7 and the example FPGA circuitry 800 of FIG. 8. In some such hybrid examples, one or more cores 702 of FIG. 7 may execute a first portion of the machine readable instructions represented by the flowchart(s) of FIGS. 4-5 to perform first operation(s)/function(s), the FPGA circuitry 800 of FIG. 8 may be configured and/or structured to perform second operation(s)/function(s) corresponding to a second portion of the machine readable instructions represented by the flowcharts of FIG. 4-5, and/or an ASIC may be configured and/or structured to perform third operation(s)/function(s) corresponding to a third portion of the machine readable instructions represented by the flowcharts of FIGS. 4-5.

It should be understood that some or all of the circuitry of FIG. 2 may, thus, be instantiated at the same or different times. For example, same and/or different portion(s) of the microprocessor 700 of FIG. 7 may be programmed to execute portion(s) of machine-readable instructions at the same and/or different times. In some examples, same and/or different portion(s) of the FPGA circuitry 800 of FIG. 8 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 700 of FIG. 7 may execute machine readable instructions in one or more threads executing concurrently and/or in series. In some examples, the FPGA circuitry 800 of FIG. 8 may be configured and/or structured to carry out operations/functions concurrently and/or in series. Moreover, in some examples, some or all of the circuitry of FIG. 2 may be implemented within one or more virtual machines and/or containers executing on the microprocessor 700 of FIG. 7.

In some examples, the programmable circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the programmable circuitry 612 of FIG. 6, which may be in one or more packages. For example, the XPU may include a CPU (e.g., the microprocessor 700 of FIG. 7, the CPU 820 of FIG. 8, etc.) in one package, a DSP (e.g., the DSP 822 of FIG. 8) in another package, a GPU in yet another package, and an FPGA (e.g., the FPGA circuitry 800 of FIG. 8) in still yet another package.

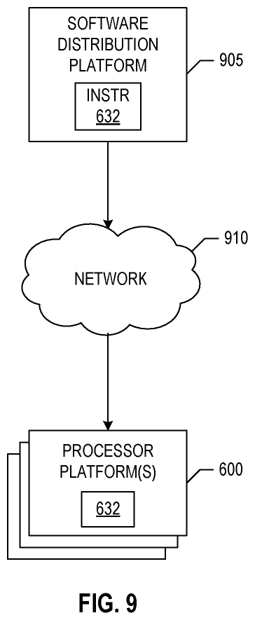

A block diagram illustrating an example software distribution platform 905 to distribute software such as the example machine readable instructions 632 of FIG. 6 to other hardware devices (e.g., hardware devices owned and/or operated by third parties from the owner and/or operator of the software distribution platform) is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions of FIGS. 4-5, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions of FIG. 4-5, may be downloaded to the example programmable circuitry platform 600, which is to execute the machine readable instructions 632 to implement the audio enhancement circuitry 102. In some examples, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that improve audio quality based on load impedance. Disclosed systems, apparatus, articles of manufacture, and methods improve the efficiency of using a computing device by providing appropriate power to audio peripheral devices. In some examples, a host 110 can, based on the audio enhancement circuitry 102, drive headphones with low impedance with a low Vrms, while driving headphones such as the high impedance headphones 104 with a relatively higher Vrms. Furthermore, examples disclosed herein do not have an additional amplifier outside the audio enhancement circuitry 102. This simplifies the audio listening process for a user, as the user can simply plug the high impedance headphones 104 into the audio enhancement circuitry 102 (e.g., via a 3.5 mm to USB-C™ adapter, directly connect a USB-C™ compatible device, a non USB-C™ device, etc.) without the need for an additional amplifier. This reduces both complexity and cost of audio peripherals, while providing superior performance.

Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to improve audio quality based on load impedance sensing are disclosed herein. Further examples and combinations thereof include the following:

Example 1 includes an apparatus comprising at least one memory, instructions, and programmable circuitry to execute the instructions to cause at least one test signal to be output to an audio device, a voltage of the at least one test signal based on a default load impedance, measure a current drawn by the audio device based on the at least one test signal, and change the voltage based on an impedance profile, the impedance profile based on the measured current.

Example 2 includes the apparatus of example 1, wherein the at least one test signal includes a first test signal and a second test signal, the first test signal associated with a first frequency, and the second test signal associated with a second frequency different from the first frequency.

Example 3 includes the apparatus of example 2, wherein the at least one test signal includes a third test signal associated with a third frequency that is different from the first frequency and the second frequency.

Example 4 includes the apparatus of example 3, wherein the first test signal, the second test signal, and the third test signal form a melody.

Example 5 includes the apparatus of example 1, wherein the audio device is an audio peripheral device coupled to a universal serial bus (USB) connector of a host device.

Example 6 includes the apparatus of example 5, wherein the audio peripheral device is a pair of headphones.

Example 7 includes the apparatus of example 1, wherein the programmable circuitry is to cause a digital to analog converter (DAC) to transmit a measurement of the current drawn by the audio device to an audio codec, the audio codec to change a frequency of an audio signal transmitted to the audio device based on the measurement.

Example 8 includes the apparatus of example 7, wherein the DAC is included in a power delivery controller, the power delivery controller coupled to the audio codec by an inter-integrated circuit communication bus, and the programmable circuitry is to cause the audio codec to determine an impedance associated with the measured current based on a current to impedance mapping stored in a lookup table.

Example 9 includes a non-transitory computer readable storage medium comprising instructions which, when executed by programmable circuitry, cause the programmable circuitry to cause at least one test signal to be output to an audio device, a voltage of the at least one test signal based on a default load impedance, measure a current drawn by the audio device based on the at least one test signal, and change the voltage based on an impedance profile, the impedance profile based on the measured current.

Example 10 includes the non-transitory computer readable storage medium of example 9, wherein the at least one test signal includes a first test signal and a second test signal, the first test signal associated with a first frequency, and the second test signal associated with a second frequency different from the first frequency.

Example 11 includes the non-transitory computer readable storage medium of example 10, wherein the at least one test signal includes a third test signal associated with a third frequency that is different from the first frequency and the second frequency.

Example 12 includes the non-transitory computer readable storage medium of example 11, wherein the first test signal, the second test signal, and the third test signal form a melody.

Example 13 includes the non-transitory computer readable storage medium of example 9, wherein the audio device is an audio peripheral device coupled to a universal serial bus (USB) connector of a host device.

Example 14 includes the non-transitory computer readable storage medium of example 13, wherein the audio peripheral device is a pair of headphones.

Example 15 includes the non-transitory computer readable storage medium of example 9, wherein the instructions, when executed, cause a digital to analog converter (DAC) to transmit a measurement of the current drawn by the audio device to an audio codec, the audio codec to change a frequency of an audio signal transmitted to the audio device based on the measurement.

Example 16 includes the non-transitory computer readable storage medium of example 15, wherein the DAC is included in a power delivery controller, the power delivery controller coupled to the audio codec by an inter-integrated circuit communication bus, the audio codec to determine an impedance associated with the measured current based on a current to impedance mapping stored in a lookup table.

Example 17 includes a method comprising causing, by executing an instruction with programmable circuitry, at least one test signal to be output to an audio device, a voltage of the at least one test signal based on a default load impedance, measuring, by executing an instruction with programmable circuitry, a current drawn by the audio device based on the at least one test signal, and changing, by executing an instruction with the programmable circuitry, the voltage based on an impedance profile, the impedance profile based on the measured current.

Example 18 includes the method of example 17, wherein the at least one test signal includes a first test signal and a second test signal, the first test signal associated with a first frequency, and the second test signal associated with a second frequency different from the first frequency.

Example 19 includes the method of example 18, wherein the at least one test signal includes a third test signal associated with a third frequency that is different from the first frequency and the second frequency.

Example 20 includes the method of example 19, wherein the first test signal, the second test signal, and the third test signal form a melody.

Example 21 includes the method of example 17, wherein the audio device is an audio peripheral device coupled to a universal serial bus (USB) connector of a host device.

Example 22 includes the method of example 21, wherein the audio peripheral device is a pair of headphones.

Example 23 includes the method of example 17, wherein the instructions, when executed, cause a digital to analog converter (DAC) to transmit a measurement of the current drawn by the audio device to an audio codec, the audio codec to change a frequency of an audio signal transmitted to the audio device based on the measurement.

Example 24 includes the method of example 23, wherein the DAC is included in a power delivery controller, the power delivery controller coupled to the audio codec by an inter-integrated circuit communication bus, the audio codec to determine an impedance associated with the measured current based on a current to impedance mapping stored in a lookup table.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
at least one memory;
instructions; and
programmable circuitry to execute the instructions to:
cause at least one test signal to be output to an audio device, a voltage of the at least one test signal based on a default load impedance;
measure a current drawn by the audio device based on the at least one test signal; and
change the voltage based on an impedance profile, the impedance profile based on the measured current.

2. The apparatus of claim 1, wherein the at least one test signal includes a first test signal and a second test signal, the first test signal associated with a first frequency, and the second test signal associated with a second frequency different from the first frequency.

3. The apparatus of claim 2, wherein the at least one test signal includes a third test signal associated with a third frequency that is different from the first frequency and the second frequency.

4. The apparatus of claim 3, wherein the first test signal, the second test signal, and the third test signal form a melody.

5. The apparatus of claim 1, wherein the audio device is an audio peripheral device coupled to a universal serial bus (USB) connector of a host device.

6. The apparatus of claim 5, wherein the audio peripheral device is a pair of headphones.

7. The apparatus of claim 1, wherein the programmable circuitry is to cause a digital to analog converter (DAC) to transmit a measurement of the current drawn by the audio device to an audio codec, the audio codec to change a frequency of an audio signal transmitted to the audio device based on the measurement.

8. The apparatus of claim 7, wherein the DAC is included in a power delivery controller, the power delivery controller coupled to the audio codec by an inter-integrated circuit communication bus, and the programmable circuitry is to cause the audio codec to determine an impedance associated with the measured current based on a current to impedance mapping stored in a lookup table.

9. A non-transitory computer readable storage medium comprising instructions which, when executed by programmable circuitry, cause the programmable circuitry to:
cause at least one test signal to be output to an audio device, a voltage of the at least one test signal based on a default load impedance;
measure a current drawn by the audio device based on the at least one test signal; and
change the voltage based on an impedance profile, the impedance profile based on the measured current.

10. The non-transitory computer readable storage medium of claim 9, wherein the at least one test signal includes a first test signal and a second test signal, the first test signal associated with a first frequency, and the second test signal associated with a second frequency different from the first frequency.

11. The non-transitory computer readable storage medium of claim 10, wherein the at least one test signal includes a third test signal associated with a third frequency that is different from the first frequency and the second frequency.

12. The non-transitory computer readable storage medium of claim 11, wherein the first test signal, the second test signal, and the third test signal form a melody.

13. The non-transitory computer readable storage medium of claim 9, wherein the audio device is an audio peripheral device coupled to a universal serial bus (USB) connector of a host device.

14. The non-transitory computer readable storage medium of claim 13, wherein the audio peripheral device is a pair of headphones.

15. The non-transitory computer readable storage medium of claim 9, wherein the instructions, when executed, cause a digital to analog converter (DAC) to transmit a measurement of the current drawn by the audio device to an audio codec, the audio codec to change a frequency of an audio signal transmitted to the audio device based on the measurement.

16. The non-transitory computer readable storage medium of claim 15, wherein the DAC is included in a power delivery controller, the power delivery controller coupled to the audio codec by an inter-integrated circuit communication bus, the audio codec to determine an impedance associated with the measured current based on a current to impedance mapping stored in a lookup table.

17. A method comprising:
causing, by executing an instruction with programmable circuitry, at least one test signal to be output to an audio device, a voltage of the at least one test signal based on a default load impedance;
measuring, by executing an instruction with programmable circuitry, a current drawn by the audio device based on the at least one test signal; and
changing, by executing an instruction with the programmable circuitry, the voltage based on an impedance profile, the impedance profile based on the measured current.

18. The method of claim 17, wherein the at least one test signal includes a first test signal and a second test signal, the first test signal associated with a first frequency, and the second test signal associated with a second frequency different from the first frequency.

19. The method of claim 18, wherein the at least one test signal includes a third test signal associated with a third frequency that is different from the first frequency and the second frequency.

20. The method of claim 19, wherein the first test signal, the second test signal, and the third test signal form a melody.

21-24. (canceled)
